(19) United States
(12) Patent Application Publication
(10) Pub. No.: US 2011/0216127 A1
(43) Pub. Date: Sep. 8, 2011

(54) PRINTHEAD WIPING SYSTEM

(75) Inventors: Vesa Karppinen, Balmain (AU); Yazhuo Li, Balmain (AU); Gerard Louis, Balmain (AU)

(73) Assignee: Silverbrook Research Pty Ltd

(21) Appl. No.: 12/719,005

(22) Filed: Mar. 8, 2010

(51) Int. Cl. B41J 2/165

(52) U.S. Cl. 347/33

(57) ABSTRACT

A maintenance system for maintaining a stationary printhead is disclosed. The maintenance system includes a porous wiper element movable longitudinally past the printhead. The wiper element contacts the printhead during movement in at least one direction of longitudinal movement. A pump is included for pumping liquid into the wiper element. A rotating means is included for spinning the wiper element to thereby spin liquid and contaminants from the wiper element. By spinning the wiper element the wetness thereof is reset to a known condition. Advantageously the wetness of the wiper element is then set to a desired level by controlling the amount of liquid pumped by the pump into the wiper element. In order to clean the wiper element, the wiper element is saturated with liquid before spinning the wiper element again, followed by another spinning operation. Other levels of wetness include a level for rehydrating the printhead, and another level for wiping the printhead.

### FIELD OF THE INVENTION

The present invention relates generally to ink-jet printing and, in particular, to an element for cleaning contaminants from a full-width array ink-jet printhead, and a maintenance station for that element.

### CROSS REFERENCES TO RELATED APPLICATIONS

The following patents or patent applications filed by the applicant or assignee of the present invention are hereby incorporated by cross-reference.

| | | | | |
|---|---|---|---|---|
| 7,364,256 | 7,258,417 | 7,293,853 | 7,328,968 | 7,270,395 |
| 7,461,916 | 7,510,264 | 7,334,864 | 7,255,419 | 7,284,819 |
| 7,229,148 | 7,258,416 | 7,273,263 | 7,270,393 | 6,984,017 |
| 7,347,526 | 7,357,477 | 11/748,482 | 7,562,960 | 11/779,851 |
| 7,524,017 | 11/853,816 | 11/853,814 | 11/853,786 | 11/872,037 |
| 11/856,694 | 11/965,703 | 11/971,170 | 12/023,011 | 12/036,896 |
| 7,588,312 | 12/264,797 | 12/324,552 | 12/422,973 | 12/493,216 |
| 12/540,365 | 7,465,015 | 7,645,023 | 7,648,223 | 12/272,741 |
| 12/630,675 | 12/649,290 | 7,364,255 | 12/056,247 | 7,357,476 |
| 12/050,001 | 11/003,614 | 7,284,820 | 7,341,328 | 7,246,875 |
| 7,322,669 | 11/764,760 | 11/853,777 | 11/955,354 | 12/022,994 |
| 7,445,311 | 7,452,052 | 7,455,383 | 7,448,724 | 7,441,864 |
| 7,637,588 | 7,648,222 | 7,669,958 | 7,607,755 | 11/482,971 |
| 7,658,463 | 12/234,688 | 12/233,590 | 12/249,951 | 12/247,187 |
| 12/264,905 | 12/568,671 | 12/626,933 | 12/649,203 | 12/696,038 |
| 12/709,495 | | | | |

### BACKGROUND

A printhead of an ink-jet printer typically contains thousands of very small nozzles arranged close to each other. The diameter of a typical nozzle opening is in the order of 15 μm. The printhead is in close contact with a substrate, such as a sheet of paper, being printed on. Debris on the substrate, such as lint or stray paper fibers, is often picked up by the printhead, causing such debris to block some of the nozzles thereby preventing proper operation.

Another cause for nozzles to cease proper operation is when the ink in the nozzles dries. Drying ink causes the pigments and dyes to dry out, thereby forming a viscous mass, or even a solid mass, that blocks the ink passageways and nozzles. Ink dying may affect the printhead as a whole, for example then the entire printhead has not been uses for some time, or may also affect individual nozzles when such nozzles have not ejected ink for some time.

Failure of even a single nozzle may cause a visible effect on the printed output by the printhead. The effect is typically a blank line across the printed output. Proper cleaning of the printhead is therefore essential to providing a quality printed output from a printhead.

To improve the reliability of printheads, most printers include a “maintenance station”. The maintenance station typically includes a flexible blade. Typically the printhead slides into the maintenance station, and contacts the flexible blade which is arranged to wipe any contaminants off the front face of the printhead. When nozzles are clogged, the printer attempts to fire all nozzles at once. Some of the ink generally wicks across the printhead. The flexible blade is wiped across the printhead to spread the ink evenly across the printhead, thereby covering nozzles containing dried ink. The dried ink in those nozzles is rehydrated by the ink swept across the printhead by the blade, and the nozzles are again all fired to dislodge any ink clumps blocking the nozzles.

The rehydration provided by prior art printers lacks control. An excessive amount of ink is ejected by all functional nozzles, and the flexible blade is used to wipe away the excess ink. However, the blade's ability to remove excess ink is limited. It is important to control the amount of rehydration since insufficient moisture results in not all nozzles being rehydrated and contaminants not being wiped away by the blade. On the other hand, a printhead with a nozzle surface which is too wet results in color mixing.

A need exists for an improved maintenance mechanism for cleaning contaminates from printheads, while providing control over the amount of moisture applied to the printhead during maintenance.

### SUMMARY

It is an object of the present invention to substantially overcome, or at least ameliorate, one or more disadvantages of existing arrangements.

According to an aspect of the present disclosure, there is provided a maintenance system for maintaining a stationary printhead, the maintenance system comprising:

a porous wiper element movable longitudinally past the printhead, the wiper element contacting the printhead during movement in at least one direction of longitudinal movement;

a pump for pumping liquid into the wiper element; and

a rotating means for spinning the wiper element to thereby spin liquid and contaminants from the wiper element.

Other aspects of the invention are also disclosed.

### BRIEF DESCRIPTION OF THE DRAWINGS

One or more embodiments of the present invention will now be described with reference to the drawings, in which:

FIG. 1 shows the printhead wiping system according to an embodiment of the present invention in a drying position;

FIG. 2 shows the printhead wiping system in a rewetting phase;

FIG. 3 shows the printhead wiping system during a phase where the wiper assembly is moved to a position from where wiping of the printhead would commence;

FIG. 4 shows the printhead wiping system at the position from where wiping of the printhead commences;

FIGS. 5 and 6 show a cross-sectional view of a wiper assembly of the printhead wiping system with a shield of the wiper assembly in an open and closed positions respectively;

FIG. 7 shows a slidable tray containing the printhead wiping system, a capper and a platen where the platen is underneath the printhead;

FIG. 8 shows the slidable tray moved to a position where the capper is underneath the printhead; and

FIG. 9 shows the slidable tray moved to a position where the wiping system is underneath the printhead.

### DETAILED DESCRIPTION INCLUDING BEST MODE

Where reference is made in any one or more of the accompanying drawings to features which have the same reference numerals, those features have for the purposes of this description the same function(s) or operation(s), unless the contrary intention appears.

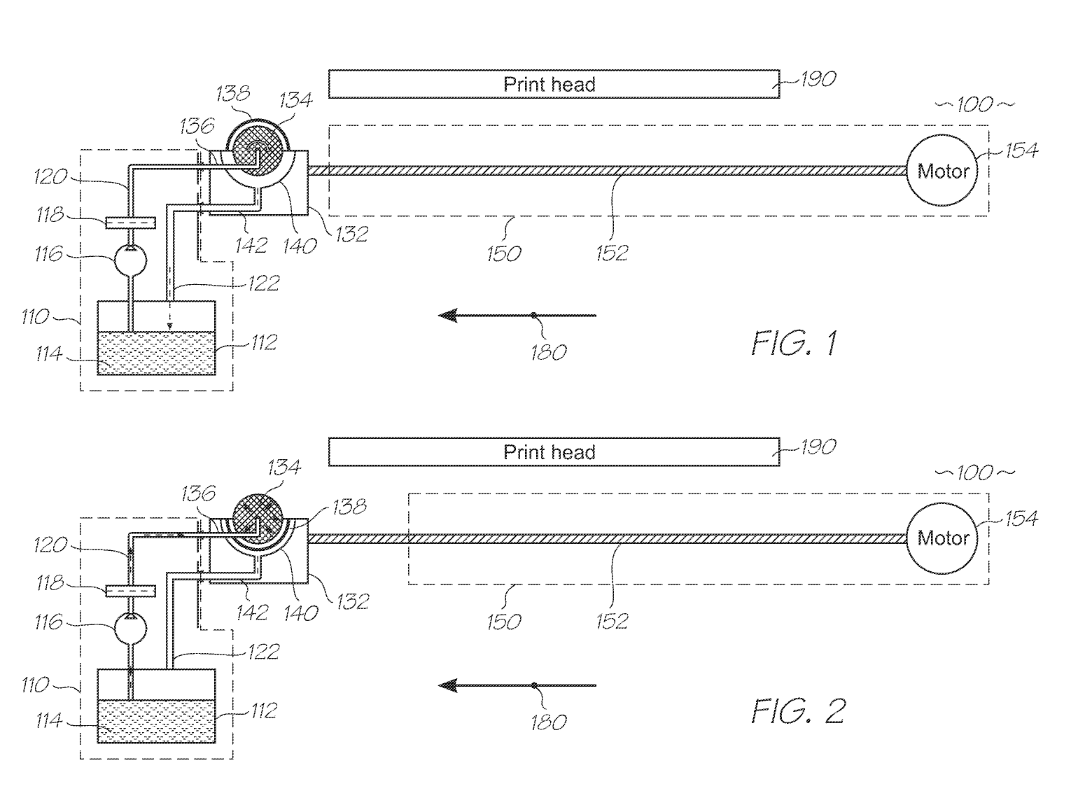

FIGS. 1 to 4 show schematic diagrams a preferred embodiment of a printhead wiping system 100 during different phases of operation. Also illustrated is a full-width array ink-jet printhead 190 cleaned by the printhead wiping system 100. The full-width array ink-jet printhead 190, which extend across the width of a sheet (not illustrated), remains stationary during printing and cleaning. The downward facing surface of the ink-jet printhead 190 has arrays of selectively-actuable ink nozzles (not illustrated). Each nozzle in printhead 190 includes an ink chamber (not illustrated) which terminates in an opening at the outer portion of the printhead 190 through which ink is ejected. Each chamber also has a heating element (not illustrated) which, when voltage is introduced therein, causes the rapid heating of liquid ink in the chamber, causing the liquid ink to be ejected out of the nozzle and onto the sheet. Auxiliary systems for the printhead 190, such as the rollers, ink supply, electrical connections, etc are known in the art and are not illustrated for simplicity.

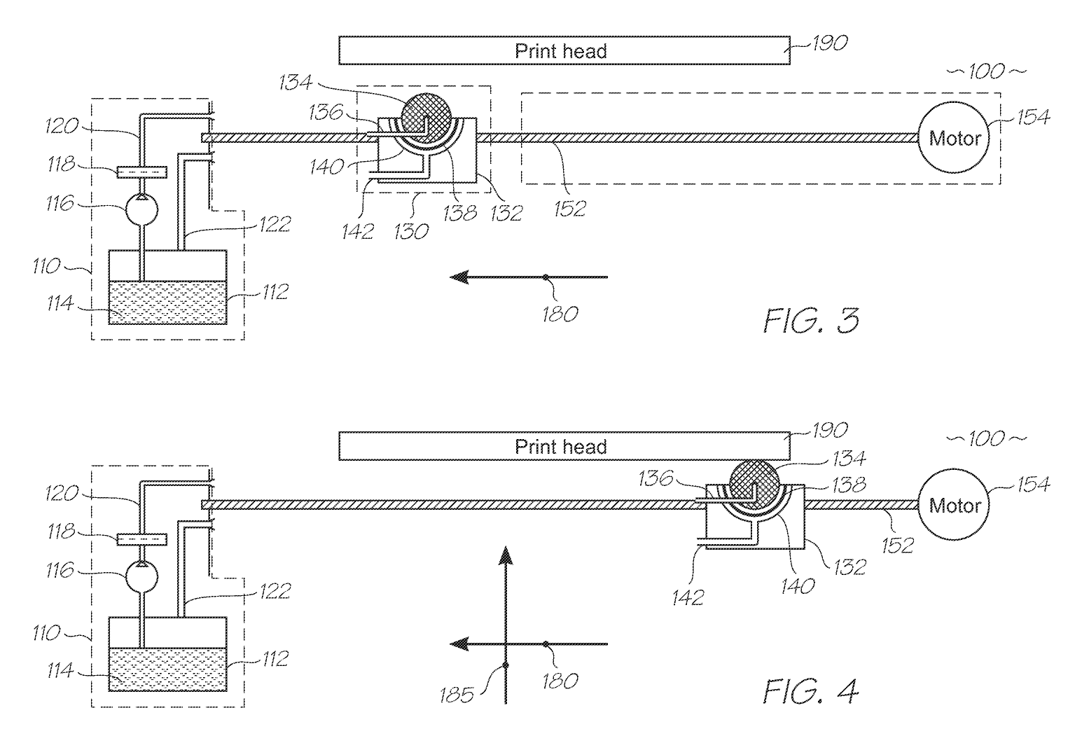

Referring to FIG. 3, the printhead wiping system 100 includes 3 sub-assemblies, namely a cleaning and wetting station 110, a wiper assembly 130 and a wiper transport assembly 150. The wiper assembly 130 includes a carriage 132 which is moved back and forth in a wiping direction 180 by the wiper transport assembly 150. The wiper transport assembly 150 includes a rotating lead screw 152, and a motor 154 which rotates the lead screw 152 axially. The carriage 132 moves longitudinally in either the wiping direction 180, or the direction opposite the wiping direction 180, dependent upon the direction of rotation of the rotating lead screw 152, in a manner familiar to one skilled in the mechanical arts.

The wiper assembly 130 also includes a cylindrical wiper element 134 having an axis of rotation perpendicular to the wiping direction 180. The body of cylindrical wiper element 134 is made from microfibers arranged around a hollow axis (not illustrated) at the core of the cylindrical wiper element 134. Preferably the cylindrical wiper element 134 is 20 mm long and has a diameter of 18 mm. The hollow axis has an inlet tube 136. Apertures in the hollow axis allow liquid pumped into the inlet tube 136 to penetrate the microfibers of the cylindrical wiper element 134.

The wiper assembly 130 further includes a shield 138 and a sump 140. The sump includes an outlet tube 142 for draining liquid from the sump 140. The shield 138 rotates 180 degrees around the axis of the cylindrical wiper element 134 between a “closed” position and an “open” position. In the closed position the shield 138 and the sump 140 jointly forms a closed receptacle around the cylindrical wiper element 134 as is illustrated in FIG. 1. In the open position the shield 138 is below the cylindrical wiper element 134, as is illustrated in FIGS. 2, 3 and 4, thereby exposing an upper portion of the cylindrical wiper element 134.

The cleaning and wetting station 110 includes a liquid tank 112, preferably containing 100 ml of rewetting liquid 114. The liquid may be water or ink. A peristaltic pump 116 is provided for pumping liquid from the liquid tank 112 through filter 118 and along supply tube 120. The peristaltic pump 116 provides very efficient control over the amount of liquid that is pumped through filter 118 and along supply tube 120 as the rate of liquid being pumped is known. A liquid return tube 122 is also provided.

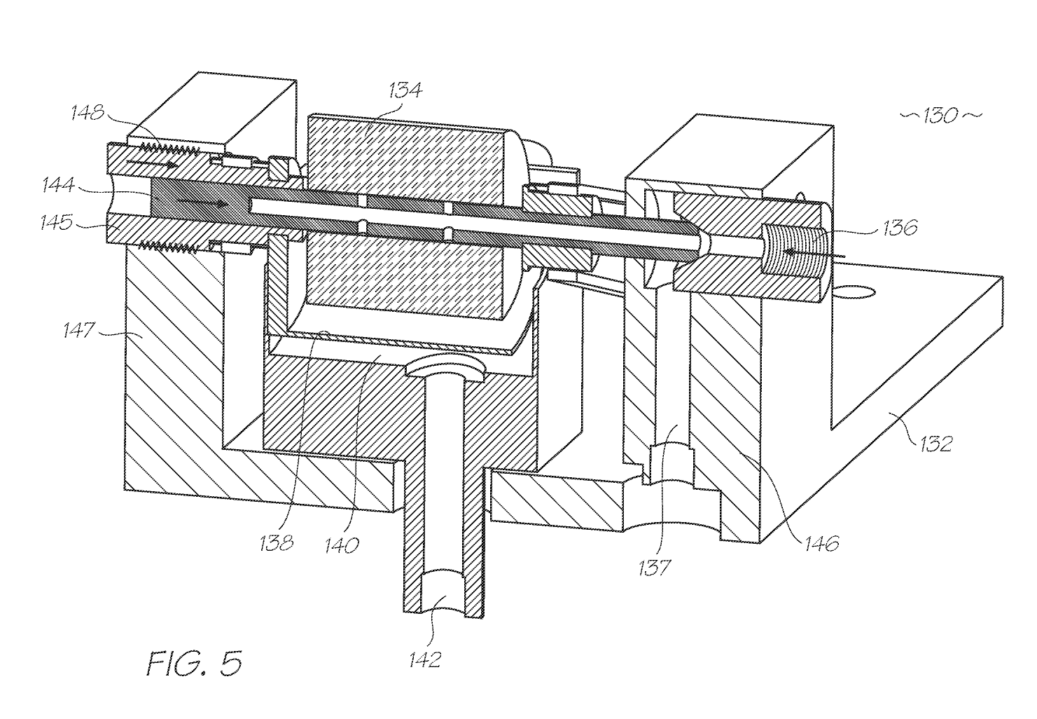

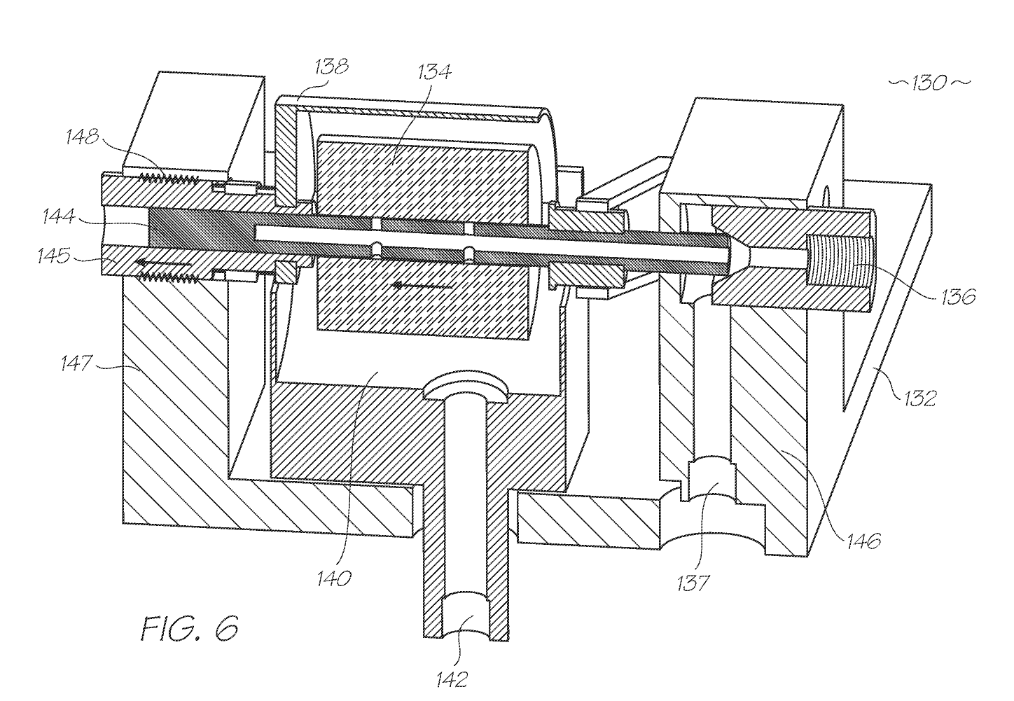

FIG. 1 shows the printhead wiping system 100 in a drying position. In that position the wiper assembly 130 is connected to the cleaning and wetting station 110. In particular, the inlet tube 136 of the wiper assembly 130 connects to the supply tube 120 of the cleaning and wetting station 110, creating a fluidic path from the pump 116 to the core of the cylindrical wiper element 134. The outlet tube 142 of the wiper assembly 130 also connects to the liquid return tube 122 of the cleaning and wetting station 110. The shield 138 is rotated to the closed position in a manner described below with reference to FIGS. 5 and 6. The wiper assembly 130 includes a motor (not illustrated) which spins the cylindrical wiper element 134 at a high rotational speed, typically 10 000 revolutions per minute (rpm), about its axis. The spinning motion of the cylindrical wiper element 134 drains any excess liquid held within its microfibers through the centrifugal forces exerted on the liquid. The liquid is sprayed against the shield 138 and sump 140, and the liquid drains via the sump 140, the outlet tube 142 and the liquid return tube 122 to the liquid tank 112. Most of the particles caught in the microfibers are also dislodged from the cylindrical wiper element 134 and carried with the liquid to the liquid tanks 112. The wiper element 134 is left damp, with all excess liquid removed. Following the spinning of the cylindrical wiper element 134 the printhead wiping system 100 goes into a stand-by mode.

FIG. 2 shows the printhead wiping system 100 in a rewetting phase. As is described below, rewetting occurs before cleaning of the wiper element 134, rehydration of the printhead 190, and wiping of the printhead 190. The shield 138 is rotated to the open position, and pump 116 pumps liquid from the liquid tank 112, through filter 118, along supply tube 120, along the inlet tube 136 of the wiper assembly 130, through the hollow axis of the cylindrical wiper element 134 from where the liquid penetrate the microfibers of the cylindrical wiper element 134 through the apertures provided in the hollow axis.

The amount of liquid pumped is conveniently controlled by the duration the pump 116 is activated, and depends on the purpose of the rewetting. When the printhead wiping system 100 has been in the stand-by mode for some time, the wiper element 134 and/or the printhead 190 would be dehydrated. Accordingly, in this condition a larger amount of liquid is pumped into the wiper element 134 compared to when the wiper element 134 is being prepared for wiping of the printhead 190. When the wiper element 134 is prepared to be cleaned, the wiper element 134 is entirely saturated with liquid before the shield 138 is closed and the wiper element 134 is spun to remove the excess liquid. Since any particles on the surface of the wiper element 134 would be suspended in the liquid after the wiper element 134 is saturated, the particles are easily spun off the wiper element 134 with the liquid.

FIG. 3 shows the printhead wiping system 100 during a phase where the wiper assembly 130 is moved in the direction opposite the wiping direction 180 to a position from where wiping of the printhead 190 would commence. The shield 138 is in the open position. As is described below with reference to FIGS. 5 and 6, when the shield 138 is in the open position, the axis of the cylindrical wiper element 134 engages with a support member (not illustrated in FIG. 3 but explained below in detail with reference to FIGS. 5 and 6), preventing rotation of wiper element 134 about its own axis.

The motor 154 starts to rotate the lead screw 152, which moves the carriage 132 longitudinally in the direction opposite the wiping direction 180. It is noted that the wiper element 134 does not contact with the printhead 190 while the wiper assembly 130 is moved past the printhead 190.

FIG. 4 shows the printhead wiping system 100 with the wiper assembly 130 after the wiper assembly 130 has moved to the end of its longitudinal movement along the lead screw 152, and has been moved in a position from where wiping can commence. The printhead wiping system 100 is first moved upwards towards the printhead 190 in direction 185. The motor 154 again starts to rotate the lead screw 152 in an opposite direction, which moves the carriage 132 longitudinally in the wiping direction 180. While the wiper assembly 130 is moved past the printhead 190 in the wiping direction 180 the wiper element 134 contacts the printhead 190, thereby rehydrating the printhead 190 and/or wiping any particles from the printhead 190. The speed of rotation of the motor 154 controls the speed the wiper element 134 wipes the printhead 190.

FIGS. 5 and 6 show a cross-sectional view of the wiper assembly 130 with the shield 138 in the open and closed positions respectively. Shield 138 has an axis 145 engaged with column 147 through tread 148. The axis 144 of the wiper element 134 rotates inside axis 145, and moves laterally with axis 145. Referring to FIG. 5, as the shield 138 is moved to the open position, axis 145 rotates. Rotation of axis 145 and the thread 148 moves the axis 145 laterally towards column 146. The axis 144 of the wiper element 134 is moved also towards column 146, causing the axis 144 to engage column 146. Engagement of axis 144 with column 146 “locks” the axis 144 to the column 146 preventing rotation of axis 144, as well as creates a fluidic seal between hollow axis 144 and inlet tube 136. Any leaks of that fluidic seal are drained through outlet 137 to liquid tank 112.

Referring to FIG. 6, as the shield 138 is moved to the closed position, rotation of axis 145 causes axis 145, and hence axis 144, to move laterally away from column 146 and towards column 147. This lateral movement of axis 144 causes the axis 144 to disengage with column 146. The axis 144, and hence the wiper element 134, are now free to be spun.

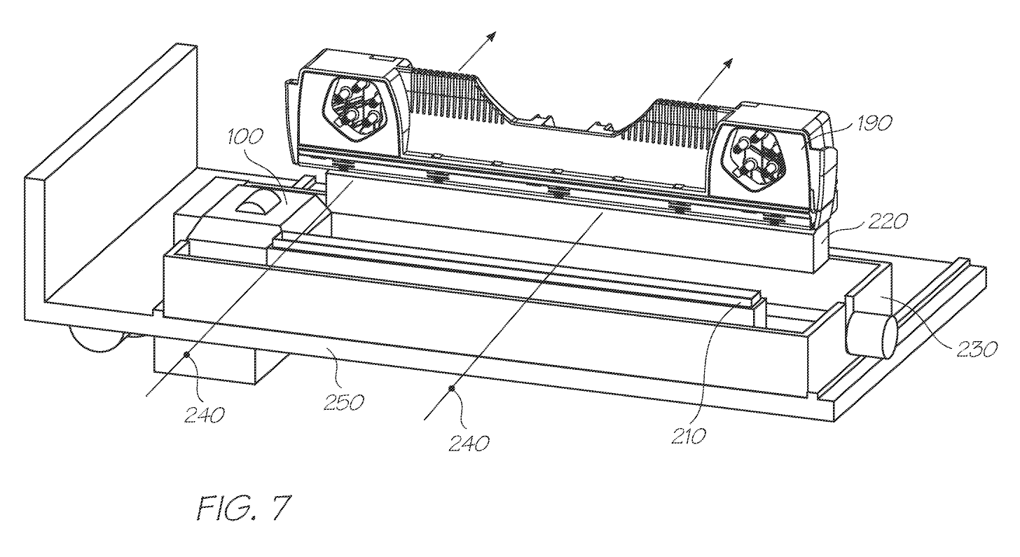

FIGS. 7 to 9 show the stationary printhead 190 in a printing position, a capped position and a cleaning/rehydration position respectively. The printhead wiping system 100, a capper 210 and a platen 220 are provided on a tray 230 slidable with respect to printer frame 250.

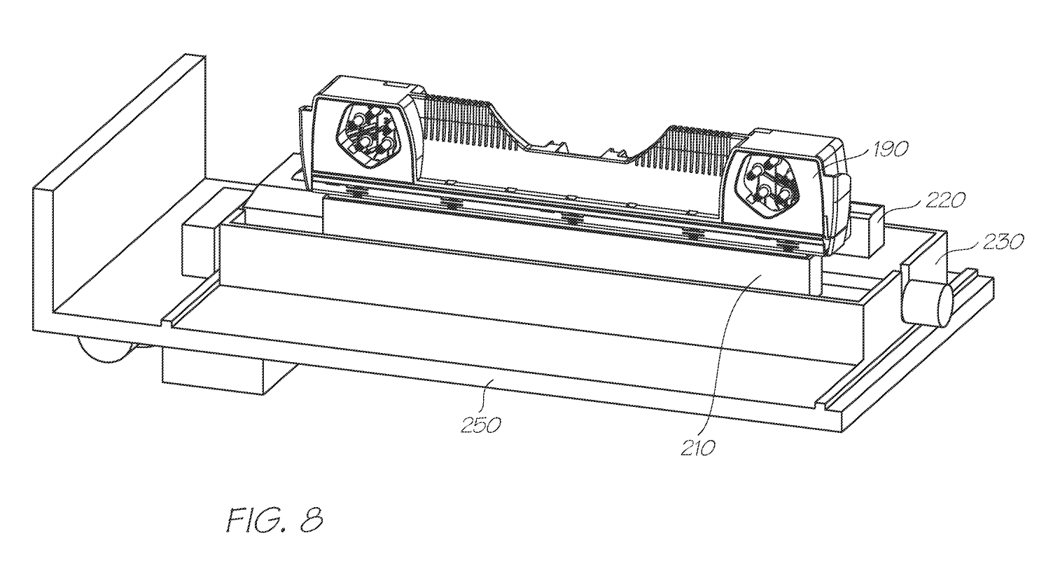

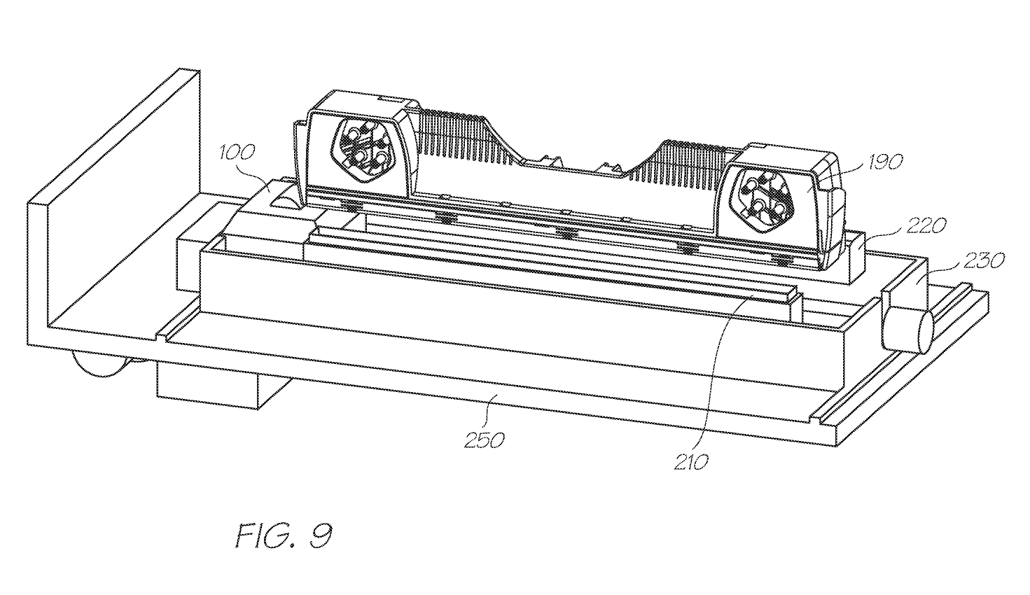

In FIG. 7 the slidable tray 230 is moved to a position where the platen 220 is underneath the printhead 190. A sheet of paper (not illustrated) is moved through a paper feed path 240 which extends between the platen 220 and the printhead 190. In FIG. 8 the slidable tray 130 has been moved to a position where the capper 210 is underneath the printhead 190. The capper 210 provides a seal over the nozzle region of the printhead 190, thereby preventing the nozzles from drying. In FIG. 9 the slidable tray 130 has been moved to a position where the wiping system 100 is underneath the printhead 190. More particular, the wiper assembly 130 is shown during a wiping operation.

The printer frame 250 has a vertical actuation mechanism (not illustrated) which lifts the element, which is one of the printhead wiping system 100, the capper 210 and the platen 220, positioned underneath the printhead 190 towards the printhead.

The sequences of operation of the printhead wiping system 100 are as follows:
After power-up of the printer the wiper element 134 is spun in order to “reset” the wetness thereof to a known condition. The wiper element 134 is next saturated with liquid, followed by another spinning operation. The second spinning operation, in addition to again resetting the wetness of the wiping element 134, also cleans the wiping element 134. The wiper element 134 is next wetted to a rehydration level before the printhead 190 is wiped by the wiping element 134.
When the printer has been left on for some time, and a first print job arrives in the printer, the wiper element 134 is spun in order to “reset” the wetness thereof to the known condition, and then wetted to wiping level before the printhead 190 is wiped by the wiping element 134. After printing a set number of pages, for example 100 pages, the printhead 190 is wiped by the wiping element 134 without additional spinning or wetting.
Following a set number of print jobs, for example 5 print jobs, the wiper element 134 is spun in order to “reset” the wetness thereof to the known condition. The wiper element 134 is next cleaned by first saturating the wiper element 134 with liquid, followed by a spinning operation. The wiper element 134 is next wetted to a wiping level before the printhead 190 is wiped by the wiping element 134.
Following the printing of a print job, and with no further print jobs arriving within a set period, for example 10 minutes, the printhead 190 is wiped by the wiping element 134 without additional spinning or wetting.

The printhead wiping system 100 has various advantages. One such an advantage is that a long period in the stand-by position is not an impediment to the operation of the printhead wiping system 100 since the wiper element 134 is restored to at optimal wetness level prior to the wiper element 134 being brought into contact with the printhead 190. By first spinning the wiper element 134 the wiper element 134 is “reset” to the known wetness condition. The desired level of wetness is then introduced into the wiper element 134 through control of the pump 116.

Another advantage of the printhead wiping system 100 is that a significantly dehydrated printhead 190 can be rehydrated by the wet wiper element 134 without the need for the printhead to “purge”. Purges consume a significant amount of ink. Yet another advantage is that the wiper element 134 is also cleaned, avoiding re-contaminating the printhead 190 by a dirty wiper element 134. Yet another advantage is achieved due to the recycling of the liquid, delaying replacement thereof.

While the invention has been described with reference to a single embodiment, it is evident that many alternatives, modifications, and variations will be apparent to those skilled in the art. Accordingly, it is intended to embrace all such alternatives, modifications, and variations as fall within the spirit and broad scope of the appended claims.

In one alternative the printhead wiping system 100 performs the drying (FIG. 1) and the rewetting (FIG. 2) while the printer is printing, that is while the platen 220 is below the printhead 190.

1. A maintenance system for maintaining a stationary printhead, the maintenance system comprising:
a porous wiper element movable longitudinally past the printhead, the wiper element contacting the printhead during movement in at least one direction of longitudinal movement;
a pump for pumping liquid into the wiper element; and
a rotating means for spinning the wiper element to thereby spin liquid and contaminants from the wiper element.

2. A maintenance system according to claim 1 wherein the wiper element has a cylindrical shape, and the wiper is spun about the axis of the cylindrical shape.

3. A maintenance system according to claim 1 wherein the wiper element has a hollow axis surrounded by a porous material, the pump pumping the liquid through the hollow axis into the porous material.

4. A maintenance system according to claim 1 wherein the porous material is microfiber.

5. A maintenance system according to claim 1 wherein the wiper element is spun about an axis perpendicular to the longitudinal movement.

6. A maintenance system according to claim 1 further comprising a shield for collecting liquid spun from the wiper element.

7. A maintenance system according to claim 6 wherein the shield movable between a first position where the wiper element is covered and a second position where the wiper element is exposed for contact with the printhead.

8. A maintenance system according to claim 7 wherein movement of the shield to the second position engages the wiper element with a support structure, thereby preventing rotation of the wiper element.

9. A maintenance system according to claim 1 further comprising a reservoir from which the liquid is pumped by the pump, wherein liquid spun from the wiper element is returned to the reservoir.

10. A maintenance system according to claim 1 wherein the pump is a peristaltic pump, and an amount of liquid pumped by the pump is controlled by the duration of operation of the pump.

11. A maintenance system according to claim 1 wherein the wiper element is spun when the wiper element is not in contact with the printhead.

12. A maintenance system according to claim 1 further comprising means for preventing rotation of the wiper element during longitudinal movement of the wiper element.
